(19) United States
(12) Patent Application Publication
(10) Pub. No.: US 2016/0143307 A1
(43) Pub. Date: May 26, 2016

(54) METHOD FOR THE PREPARATION OF A DAIRY GEL BY MEANS OF A HIGH PRESSURE TREATMENT

(71) Applicant: FRIESLAND BRANDS B.V., Amersfoort (NL)

(72) Inventors: Johanna Maria Jozefa Georgina LUYTEN, Wageningen (NL); Everhardus Jacobus Franciscus VAN AREM, Wageningen (NL); Ruben Frederik Maarten DE VRIES, Wageningen (NL)

(73) Assignee: FRIESLAND BRANDS B.V., Amersfoort (NL)

(21) Appl. No.: 14/889,360

(22) PCT Filed: May 5, 2014
(86) PCT No.: PCT/NL2014/050287

§ 371 Date: Nov. 5, 2015

(30) Foreign Application Priority Data
May 8, 2013 (EP) 13166966.5

(51) Int. Cl. A23C 9/18; A23C 9/156

(52) U.S. Cl. CPC A23C 9/18; A23C 9/156

(57) ABSTRACT

A first aspect of the present invention relates to a method for the preparation of dairy gels from a dairy composition by means of a high isostatic pressure treatment. A second aspect of the present invention further relates to dairy gels obtainable by such method and a third aspect of the present invention relates to the use of such gels in food products.

### TECHNICAL FIELD OF THE INVENTION

The present invention relates to a method for the preparation of dairy gels from a dairy composition by means of a high isostatic pressure treatment. The present invention further relates to dairy gels obtainable by such method and the use of such gels in food products.

### BACKGROUND OF THE INVENTION

Food gels according to their constructing materials are classified as either protein gels or polysaccharide gels. Gels are systems which are composed of a solid dissolved or dispersed in a solvent. Furthermore, gels are coherent, i.e. that both solid and solvent phases of a gel should spread persistently and are interconnected throughout the whole systems.

Protein gels are commonly used in the food industry for reasons that they contribute significantly to the color, flavor and nutritional value of food products. Furthermore, protein gels are relatively easy to use and are generally considered safe.

However, compared to polysaccharide gels, some protein gels are vulnerable to syneresis and precipitation (Renard et al., 2006, Food hydrocolloids 20 (4), 423-431). Their incorporation in foods can be a challenge in applications wherein they are heated for reasons that they tend to aggregate at high temperatures. Thus, for example protein-based fat replacers, such as micro-particulated proteins, are usually used in products which will not be subjected to further cooking.

There are various ways for preparing protein gels. One of the ways for preparing such gels is to subject protein solutions to high hydrostatic pressure treatments. Under pressure, biomolecules, such as proteins, obey the Le Chatelier-Braun principle, i.e. whenever a stress is applied to a system in equilibrium, the system will react so as to counteract the applied stress. Thus, reactions that result in reduced volume will be promoted under high pressure. This phenomenon is used for preparing protein gels by means of high isostatic pressure treatment.

Without wishing to be bound by any theory, it is assumed that upon application of a high isostatic pressure, the electrostatic interactions, hydrogen bonds and hydrophobic interactions are at least partially disrupted. Due to this disruption of the various bonds and interactions a gel is formed upon release of the isostatic pressure. In this regard, besides the pressure applied, the protein concentration, the pH as well as the level of pressure and holding times are recognized as substantial factors influencing the protein gels obtained by high pressure treatment.

Although, various factors are known for adapting the gel strength it has up till now proved to be difficult to prepare, by means of high pressure treatment, dairy gels with a substantially neutral or basic pH, a relatively high water content and with a long shelf life without having to use coagulants such as rennet.

In the international patent application WO 2012/091562 a method has been described for preparing dairy gels by means of high isostatic pressure treatment. However, in order to obtain gels, which are stable over prolonged periods of time, the use of coagulants appeared to be necessary.

In Famelart et al. 1998, Journal of Food Engineering 36 pp. 149-164, the preparation of dairy gels comprising from 5-10% by weight protein by means of high pressure treatment of skim milk concentrates has been disclosed without the use of coagulants. However, in order for a gel to form an acidic pH proved to be essential. It was further found that an optimal pH for preparing such dairy gels was 5.8. However, at such a pH the gel will be perceived by consumers as relatively sour, thereby limiting its use in food products. Furthermore, even at the preferred pH the gels obtained had a relatively low fracture stress and were not very stable.

Furthermore, in Amelia and Barbano, 2013 J. Dairy Sci 96:1-10, it is shown that at low temperatures (4° C.) a gel is formed from MCI. However this structure disappears at room temperature.

Hence a need remains for the provision of stable dairy gels with a substantially neutral or basic pH and a relatively high water content and which gels do not comprise coagulants, such as rennet, or acid for forming said gels.

### SUMMARY OF THE INVENTION

With the method of the present invention it has become possible to prepare dairy gels by means of high isostatic pressure treatment with a substantially neutral or basic pH, a relatively high water content and without having to use coagulants or agents for lowering the pH. Furthermore, due to the improved properties of the dairy gels according to the present invention, it is possible to use them in a wide variety of applications, in particular food applications.

A first aspect of the present invention relates to a method for preparing a dairy gel, comprising the steps of:

i) providing a liquid dairy composition comprising:
a water content of 60 to 90% by weight;
a pH of at least 6.5;
a dairy protein content of 15 to 30% by weight, wherein at least 80% by weight of said dairy protein is casein; and wherein on a weight basis the ratio of total calcium to dairy protein is below 0.040; and
   ii) subjecting the dairy composition to a high isostatic pressure treatment such that a dairy gel is formed.

As said, with the method according to the present invention it is possible to prepare dairy gels with a substantially neutral or basic pH, a relatively high water content and which gels are stable for a prolonged period of time. Furthermore, in order to prepare such gels no additives, such as coagulants or agents for lowering the pH are necessary. This is particularly advantageous for reasons that the use of additives in food products is becoming increasingly controversial.

A second aspect of the present invention relates to dairy gels obtainable by the above mentioned method.

A third aspect of the present invention relates to a dairy gel comprising:
a water content of 60 to 90% by weight;
a dairy protein content of 15 to 30% by weight, wherein on a weight basis at least 80% of the dairy protein is casein;
pH of at least 6.5;
on a weight basis a ratio of total calcium to dairy protein of below 0.040; and
wherein on a weight basis less than 50% of any κ-casein present in the dairy gel is para-κ-casein.

A fourth aspect of the present invention relates to a food product comprising or prepared from a dairy gel as described above.

### DEFINITIONS

The term “dairy gel” as used herein has its normal scientific meaning and refers to a viscoelastic solid prepared from amongst others dairy proteins, i.e. a system which depending on the circumstances can flow like a viscous liquid and in others behave like an elastic solid (D. S. Horne et al, International Dairy Journal (1999), pp. 261-268)

The term “milk” as used herein has its normal scientific meaning and refers to the liquid produced by the mammary glands of mammals, such as bovines (e.g. cows), goats, sheep or camels.

The term “skim milk” as used herein has its normal scientific meaning and refers to a milk comprising a relatively low amount of fat, i.e. below 1% by weight of the milk.

The term “dairy protein” as used herein has its normal scientific meaning and refers to proteins present in milk from human or non-human mammals, such as bovines (e.g. cows), goats, sheep or camels.

The term “protein” as used herein has its normal scientific meaning and refers to a linear polypeptide comprising at least 10 amino acid residues.

The term “total calcium” as used herein has its normal scientific meaning and refers to the total amount of calcium (colloidal and non-colloidal) present in a milk composition.

The term “high isostatic pressure treatment” as used herein has its normal scientific meaning and refers to a treatment wherein an isostatic pressure of 100 to 1000 MPa is applied to a product, such as a milk composition, during a pre-defined period of time.

The term “casein” as used herein has its conventional meaning (Walstra et al., 2006) and comprises native casein and micellar casein, but does not refer to sodium caseinate, potassium caseinate or calcium caseinate.

The term “coagulant” as used herein has its normal scientific meaning and refers to enzymes or agents able to specifically split the Phe-Met bond of κ-casein.

### DETAILED DESCRIPTION OF THE INVENTION

A first aspect of the present invention relates to a method for preparing a dairy gel, comprising the steps of:

i) providing a liquid dairy composition comprising:
a water content of 60 to 90% by weight;
a pH of 6.5 or higher;
a dairy protein content of 15 to 30% by weight, wherein at least 80% by weight of said dairy protein is casein; and wherein on a weight basis the ratio of total calcium to dairy protein is below 0.040; and
   ii) subjecting the dairy composition to a high isostatic pressure treatment such that a dairy gel is formed.

With the method according to the present invention it is possible to prepare dairy gels with substantially neutral or basic pH, a relatively high water content and which are stable for a prolonged period of time. Furthermore, in order to prepare such gels no additives, such as coagulants or agents for lowering the pH are necessary. Since the use of additives is becoming increasingly problematic the present invention provides significant advantages over the known methods for preparing dairy gels.

The gels prepared with the method according to the present invention had a consistency which varied from set yoghurt like structures to hard-boiled egg-like structures, which depended amongst others on the amount of protein used and the pH.

In the dairy composition and the gel prepared thereof less than 50% of any κ-casein present in the liquid dairy composition is para-κ-casein, preferably less than 20% is para-κ-casein, more preferably less than 10% is para-κ-casein. In other words, due to the absence of coagulants, such as rennet, κ-casein will not have been split substantially into glycomacropeptide (GMP) and para-pκ-casein.

The dairy composition and the gel prepared thereof will typically comprise less than 0.001 wt % coagulant, particularly rennet (chymosin). Preferably, the dairy composition and the gel does not comprise any coagulant, such as rennet.

Thus, if milk, preferably skim milk, is used for the preparation of the dairy composition, the total amount of κ-casein present in the dairy gel will be substantially the same as the amount present in the dairy composition used for preparing said gel.

Typically, if milk is used for preparing the dairy composition of step i), the amount of κ-casein in the dairy gel obtained with the method according to the present invention will be between 5-15% by weight of the total amount of casein in the dairy gel.

The inventors have further found that the amount of calcium in the dairy composition which is subjected to the high isostatic pressure treatment has a considerable influence on the fracture stress, viscosity and stability of the dairy gels prepared. Contrary to what was generally assumed, it proved to be advantageous to lower the amount of total calcium in the dairy composition. It was found that the good results are obtained when the ratio of total calcium to dairy proteins was lower than in milk, i.e. 0.042.

Hence, the ratio of total calcium to dairy proteins in the dairy composition of step i) should, on a weight basis, be below 0.040 (i.e. a ratio of 1:25, respectively). Preferably, on a weight basis the ratio of total calcium to dairy protein is below 0.035 (i.e. 1:28, respectively), more preferably below 0.032 (i.e. 1:31, respectively).

In this regard it is noted that for the calculation of the total amount of calcium in the dairy composition and the dairy gel according to the present invention, the calcium content of additional food ingredients, such as fruits or vegetables is not taken into consideration.

The total amount of calcium may be determined by methods well known to the skilled person, a suitable method for determining the calcium concentration in the dairy composition or dairy gel is method 984.27 of the Association of Analytical Communities (AOAC).

The dairy composition of step i) may be prepared by different methods well known to the person skilled in the art. It may be prepared from concentrates or isolates from milk, such as milk protein concentrate (MPC) or milk protein isolates (MPI). However, it may also be prepared from dairy protein powders, such as for example skim milk powder. In this regard reference is made to Walstra et al., Dairy Science and Technology, 2006, which is herewith incorporated by reference.

A particularly preferred way for preparing the dairy composition according to the present invention is to subject milk, preferably skim milk to a dry matter increasing treatment, such as a concentration or isolation treatment. The milk used may previously have been subjected to treatments such as heating, homogenization and/or centrifugation.

The dry matter increasing treatment of milk is preferably carried out by means of a membrane filtration treatment. A first advantage of such a treatment is that no off-taste develops, as is the case when heat-treatment is used. Another advantage is that the total amount of calcium is lowered compared to the amount of casein. In other words, the weight ratio of total calcium to casein in the dairy composition obtained is below the weight ratio in the milk used for preparing the dairy composition.

The membrane filtration treatment preferably comprises an ultrafiltration treatment or microfiltration treatment. Alternatively, it is also possible to first carry out a microfiltration treatment and subsequently an ultrafiltration treatment. However, it is preferred to use an ultrafiltration treatment (Walstra et al. Dairy Science and Technology, 2006). Both microfiltration and ultrafiltration may be followed by a diafiltration step, which makes it possible to attain the desired dry matter and protein content of the dairy composition. The skilled person is aware of these techniques and how to apply them.

The dairy composition of step i) of the present invention should comprise a dairy protein content between 15 to 30% by weight of the composition. If the dairy composition comprises less protein, it will not be possible to prepare suitable gels within the claimed pH range, in case the dairy composition comprises more protein, the gel formed will become too thick and will not be suitable for further processing.

Preferably, the dairy composition of step i) has a protein content of 18 to 25% by weight of the dairy composition.

On a weight basis at least 80% of the protein in the dairy composition or in the dairy gel is casein, preferably at least 85% is casein and more preferably at least 90% is casein. Consequently, the amount of serum proteins, e.g. whey proteins, in the dairy composition and gel obtained will be relatively low, which has a beneficial influence on the properties of the dairy gel obtained.

The pH of the dairy composition should be higher than 6.5. Preferably the pH of the milk concentrate ranges from 6.5 to 8, most preferably from 7 to 8.

In a particularly preferred embodiment of the present invention the pH of the dairy composition ranges from 6.5 to 8 and the dairy protein content ranges 15 to 30% by weight. In another preferred embodiment the pH of the dairy composition ranges from 7 to 8 and the dairy protein content ranges from 15 to 30% by weight.

Most preferably, the dairy composition comprises from 15 to 30% by weight casein and has a pH in the range of 6.5 to 8.

The dairy composition with the characteristics as described above is in accordance with the method of the present invention subjected to a high isostatic pressure treatment. The high isostatic pressure processing of foods generally involves the treatment of a product at a pressure in the range of 100 to 1000 MPa.

Since high pressure treatments have been known to the skilled person for well over a century, methods to exert the pressure are well within the ambit of normal skills of the skilled person. Preferably, the pressure is applied as a hydrostatic pressure, wherein the pressure is exerted onto the product by a surrounding fluid (preferably water). As a result the product will acquire the pressure of the surrounding medium instantaneously, and the pressure is distributed evenly throughout the product.

As the skilled person will be aware, in the case of a liquid product, the high pressure treatment can be applied with or without the use of a separate processing liquid. In the former case, a processing liquid (preferably water) will be made to surround a product that is in a packaged form (e.g. in a bag). In the latter case, the liquid product itself will also assume the function of the processing liquid. Within the context of the present invention this will be the dairy composition of step i).

For high isostatic pressure treatments of solids as well as liquid food products many kinds of equipments are available. Generally, such equipment comprises a vessel of suitable strength to sustain the pressure, and pressure generating means. The vessel will hold the food product, and can have a processing fluid (such as water) which surrounds the product, and will have a suitable closure so as to maintain pressure during processing. As said, if the food product itself is a liquid, such as a milk concentrate, a processing fluid may not be necessary. High hydrostatic pressure is generally built up by pumping additional processing fluid into the vessel (additional fluid in the vessel will lead to increased pressure), or by compressing a fluid by means of a piston.

As the skilled person is well aware, systems exist for high pressure treatment of solid food products as well as of liquid food products. Systems are available, which operate in a batch process or which operate as a continuous process. A continuous system for high pressure treatment of liquid products is amongst others described in WO97/43914.

Preferred pressures applied in accordance with the present invention range from 100 to 1000 MPa, preferably 100 to 900 MPa, more preferably 150 to 500 MPa. The duration of the high isostatic pressure treatment can be varied. Typically, the high pressure treatment will take 0.1 seconds to 15 minutes, preferably 1 minute to 10 minutes.

The high isostatic pressure treatment is generally conducted at a temperature of 5° C. to 80° C., preferably 15° C. to 25° C.

In a preferred embodiment of the present invention, the liquid dairy composition of step i) is already packaged, e.g. in a plastic bag or container before it is subjected to the high isostatic pressure treatment. This is advantageous for reasons that the filling of the package can take place while the dairy composition is still liquid, making it easier to dose the right amount of product in the package. Another important advantage is that because the gel forms within the package, it does not have to be subjected to further processing steps such as pumping and dosing, which process steps may cause contamination with micro-organisms or may have a negative impact on the physical properties of the gel.

This is particularly relevant when to the dairy composition of the method according to the present invention additional food ingredients are added, such as fruits, vegetables, edible fibers, cereals, chocolate, nuts, grains or combinations or parts thereof.

Most preferably, whole fruit, vegetables or nuts are added to the dairy composition prior to the high isostatic pressure treatment

Besides the above mentioned food ingredient, other ingredients may also be added to the dairy composition prior to the high isostatic pressure treatment. Typical food ingredients which may be used are fat, cream, vitamins, coloring agents, flavoring agents, edible fibers (such as galacto-oligosaccharides or fructo-oligosaccharides) or combinations thereof.

A second aspect of the present invention relates to a dairy gel obtainable by the method as described above. This dairy gel has a relatively high water content and is stable for a prolonged period of time. The pH of said gel is substantially neutral or basic, i.e. it has a pH of 6.5 or higher, preferably the pH ranges from 6.5 to 8, more preferably from 7 to 8.

In a particularly preferred embodiment of the dairy gel according to the present invention, the pH ranges from 6.5 to 8 and the amount of dairy protein ranges from 15 to 30% by weight. In another preferred embodiment, the pH ranges from 7 to 8 and the amount of dairy protein ranges from 15 to 30% by weight.

Most preferably, the dairy gel comprises from 15 to 30% by weight casein and has a pH in the range of 6.5 to 8.

Since the gel does not comprise substantial amounts of coagulants, less than 50% of any κ-casein present in the dairy gel is para-κ-casein, preferably less than 20% is para-κ-casein, more preferably less than 10% is para-κ-casein.

If the dairy gel has been prepared from milk, the amount of κ-casein in the dairy gel according to the present invention is typically between 5 to 15% by weight of the total amount of casein in the dairy gel.

A third aspect of the present invention relates to a dairy gel comprising:
a water content of 60 to 90% by weight;
a dairy protein content of 15 to 30% by weight, wherein on a weight basis at least 80% of the dairy protein is casein;
pH of 6.5 or higher;
on a weight basis a ratio of total calcium to dairy protein below 0.040; and
wherein on a weight basis less than 50% of any κ-casein present in the dairy gel is para-κ-casein.

On a weight basis the ratio of total calcium to dairy protein is preferably lower than 0.035 (i.e. 1:28, respectively), more preferably below 0.032 (i.e. 1:31, respectively).

The pH of the dairy gel should be higher than 6.5. However, a pH in the range of 6.5 to 8, particularly 7 to 8 is preferred.

In a particularly preferred embodiment of the dairy gel according to the present invention, the pH ranges from 6.5 to 8 and the amount of dairy protein ranges from 15 to 30% by weight. In another preferred embodiment, the pH ranges from 7 to 8 and the amount of dairy protein ranges from 15 to 30% by weight.

Most preferably, the dairy gel comprises from 15 to 30% by weight casein and has a pH in the range of 6.5 to 8.

This dairy gel has preferably been prepared by the method and the preferred embodiments thereof as has been described above.

A last aspect of the present invention relates to food products comprising a dairy gel as described above.

The present invention will be illustrated further by means of the following non-limiting examples.

### EXAMPLES

### Example 1

Dairy gels were prepared by using high hydrostatic pressure treatments. For the preparation of such dairy gels different milk concentrates prepared from skim milk were used. The milk concentrates differed from each other in the concentration calcium and in the ratio of casein and serum proteins.

### Skim Milk

Thermized skimmed milk (3 minutes, 62° C.) was obtained directly from the milk factory. No additional pasteurization treatment was applied. The skim milk comprised about 0.5% by weight fat and about 0.13 wt % calcium.

### Concentration Treatment

Milk concentrates were prepared by subjecting 250 kg skim milk (as mentioned above) to an ultrafiltration treatment and a subsequent microfiltration treatment (both having a ceramic membrane) until a concentrate with a casein content of 20 wt % (i.e. a total dairy protein content of 24% by weight) and a lactose content of less than 1 wt % was obtained. The pH of the concentrates was about 7. By means of dilution samples comprising 15 wt % and 17.5 wt % casein content were prepared, the processing parameters were as follows: S 150 with Ceramen membrane 0.1 μm.

Milk Concentrates with Different Calcium Concentrations

In order to examine the influence of calcium on the firmness of the dairy gels prepared from the milk concentrates, the calcium concentration of the milk concentrates obtained was altered by means of the addition of CaCl₂.2H₂O.

Samples of the concentrates were prepared which comprised an additional 0%, 5%, 10% and 15% calcium. In the samples which did not comprise additional calcium the casein/calcium ratio was 0.035, on a weight basis.

### High Pressure Treatment

The different milk concentrate samples as described in the foregoing were subjected to high pressure treatment with the aim to prepare a dairy gel.

The high pressure treatments were performed with a Resato type WPA-520-1/B/D, applied with a Resato pump type P160-520-1/II/V. Standard high pressure treatment was 300 MPa for 5 minutes, including pressure drop time. Pressure release was done as fast as possible (about 20 seconds). The temperature was about 20° C.

### Analysis

In the cases were a dairy gel was formed after the high pressure treatment, the firmness of the gel obtained was examined. To this end the maximum compression force of a 2.5 cm*2.5 cm*2.5 cm block of the dairy gel of the different samples was analyzed with a Texture Analyser (speed 1 mm/s). The gels obtained had a different appearance and stiffness, ranging from a set yoghurt like structure to a white part of a hard boiled egg structure. The gels were classified as follows:
Strong gel: compression force >600 g
Medium-strong gel: compression force 300-600 g
Soft gel: compression force 100-300 g
Very soft gel: not measureable with method described, but comparable to a set yoghurt like structure

### Results

The results of the analysis of the dairy gels prepared with the milk concentrates as described above has been depicted in table 1 below. The pH of the dairy gels was about 7.

TABLE 1
Firmness (g) (max load/final load)

| Casein | no Ca²⁺ | +5% | +10% | +15% |
|---|---|---|---|---|
| (wt %) | added | Ca²⁺ | Ca²⁺ | Ca²⁺ |
| 20 | strong | medium | medium | Medium |
| 17.5 | soft | very soft | very soft | soft |
| 15 | very soft | very soft | very soft | very soft |

From the results above it is clear that firm gels can be formed, but also soft gels and very soft gels. The texture obtained depended on protein and Ca content. Contrary to what was expected, it has now been possible to prepare dairy gels at substantially neutral pH with a relatively high amount of dairy protein. Furthermore, other than suggested in for example Farmelat et al, it has also been shown that at a pH of 6.5 or higher a higher amount of dairy protein, in particular a higher amount of casein, provides a more firm gel.

1.-16. (canceled)

17. A method for preparing a dairy gel, comprising:
subjecting a liquid dairy composition to a high isostatic pressure treatment, the composition comprising:
(a) a water content of 60 to 90% by weight;
(b) a pH of 6.5 or higher;
(c) a dairy protein content of 15 to 30% by weight,
wherein at least 80% by weight of the dairy protein is casein; and
wherein on a weight basis the ratio of total calcium to dairy protein is below 0.040; and
wherein the composition forms a dairy gel.

18. The method according to claim 17, wherein the dairy composition has a dairy protein content of 18 to 25% by weight.

19. The method according to claim 17, wherein on a weight basis at least 85% of the protein is casein.

20. The method according to claim 17, wherein on a weight basis the ratio of total calcium to dairy protein is lower than 0.035.

21. The method according to claim 17, wherein the dairy composition has been prepared by means of a membrane filtration treatment.

22. The method according to claim 21, wherein the membrane filtration treatment is ultrafiltration treatment and/or microfiltration treatment.

23. The method according to claim 17, wherein on a weight basis less than 50% of any κ-casein present in the liquid dairy composition is para-κ-casein.

24. The method according to claim 23, wherein on a weight basis less than 20% of any κ-casein present in the liquid dairy composition is para-κ-casein.

25. The method according to claim 17, wherein the pH of the dairy composition is 6.5 to 8.

26. The method according to claim 17, wherein the high isostatic treatment is conducted by subjecting the dairy composition to a isostatic pressure of 100 to 1000 MPa.

27. The method according to claim 26, wherein the high isostatic treatment is conducted by subjecting the dairy composition to a isostatic pressure of 100 to 500 MPa

28. The method according to claim 17, wherein the high isostatic pressure treatment is conducted for a duration of 0.1 seconds to 15 minutes.

29. The method according to claim 28, wherein the high isostatic pressure treatment is conducted for a duration of 1 minute to 10 minutes.

30. The method according to claim 17, wherein the high isostatic pressure treatment is conducted at a temperature of 5° C. to 80° C.

31. The method according to claim 30, wherein the high isostatic pressure treatment is conducted at a temperature of 15° C. to 25° C.

32. The method according to claim 17, wherein the dairy composition is packaged prior to the high isostatic pressure treatment of step.

33. The method according to claim 17, wherein the dairy composition of further comprises vitamins, fat, cream, coloring agents, flavoring agents, edible fibers, fruit, vegetables, cereals, chocolate, nuts, grains or a combination of any of these ingredients.

34. A dairy gel obtainable by the method according to claim 17.

35. A dairy gel comprising:
(a) a water content of 60 to 90% by weight;
(b) a dairy protein content of 15 to 30% by weight, wherein on a weight basis at least 80% of the dairy protein is casein;
(c) pH of 6.5 or higher;
(d) on a weight basis a ratio of total calcium to dairy protein below 0.040; and
(e) wherein on a weight basis less than 50% of any κ-casein present in the dairy gel is para-κ-casein.

36. The dairy gel according to claim 35, wherein on a weight basis the ratio of total calcium to dairy protein is lower than 0.035.
